(19) United States
(12) Patent Application Publication
(10) Pub. No.: US 2010/0014531 A1
(43) Pub. Date: Jan. 21, 2010

(54) ESTABLISHING PSEUDOWIRES IN PACKET SWITCHING NETWORKS

(75) Inventors: Shafiq PIRBHAI, Kanata (CA); Christopher Edward Trader, Dunrobin (CA); Allan Phoenix, Ottawa (CA)

Correspondence Address: Kramer & Amado, P.C., 1725 Duke Street, Suite 240, Alexandria, VA, 22314, US

(73) Assignee: ALCATEL LUCENT, Paris (FR)

(21) Appl. No.: 12/176,199

(22) Filed: Jul. 18, 2008

(51) Int. Cl. H04L 12/66

(52) U.S. Cl. 370/401

(57) ABSTRACT

Embodiments of the invention enable a pseudowire to be dynamically established over a PSN tunnel when the tunnel includes both statically configured segments and dynamically configured segments. Advantageously, these embodiments enable a network node that supports only static tunnel and pseudowire configuration to be included in dynamically configured pseudowires.

### FIELD OF THE INVENTION

The invention is directed to communication networks, and in particular to setting up a pseudo wire (PW) that uses a tunneled connection having statically configured and dynamically configured segments.

### BACKGROUND OF THE INVENTION

A pseudowire is a mechanism for carrying a native telecommunications service (e.g. T1 leased line, Frame Relay, Ethernet) over a packet switching network in a transparent manner emulating a wired connection. Typically the PSN uses Internet Protocol (IP) or Multi Protocol Label Switching (MPLS) packet forwarding. Protocol data units (PDUs) of the native service are communicated between two customer edge (CE) systems, wherein each CE system originates and/or terminates the native service. Typically, the CE systems engage in bidirectional communications using the native service carried by a pseudowire.

Each of the CE systems is connected to a respective provider edge (PE) system by an attachment circuit. A pseudowire is provided between the PE systems via a tunneled connection established through the PSN. A tunneled connection is also referred to herein as a PSN tunnel or tunnel. Various types of PSN tunnels can be used, as established using tunnel signaling such as Layer-2 Tunneling Protocol (L2TP), MPLS Label Distribution Protocol (LDP), and Resource Reservation Protocol-Traffic Engineering (RSVP-TE). PW/PE maintenance signaling is used to establish, maintain, and tear down pseudowires, as well as coordinate any parameters relating to endpoints of a pseudowire. The tunnel signaling protocol may be extended to provide mechanisms that enable the PE systems to exchange all information necessary to setup a pseudowire. Pseudowires can also be manually configured.

In operation, a native service PDU is received by a PE system from an originating CE system over an attachment circuit. The native service PDU is encapsulated to form a PW-PDU, and the PW-PDU is then sent to a peer PE system over a pseudowire between the two PE systems. The peer PE system receives the PW-PDU, decapsulates the PW-PDU to yield the native service PDU, and then sends the native service PDU to a terminating CE system via a corresponding attachment circuit.

More information on pseudowires can be found in “Pseudo Wire Emulation Edge-to-Edge (PWE3) Architecture”, RFC3985, IETF, March 2005, by S. Bryant and P. Pate, which is incorporated herein by reference

As already mentioned, pseudowires are useful for carrying various native telecommunications services over a PSN. One such service finding growing use is Circuit Emulation Service (CES) over a packet switching network (CESoPSN). Carriers can realize cost savings by moving Time Division Multiplex (TDM) circuits onto CESoPSN. For more information on carrying structured (i.e. N×DS0) TDM signals over pseudowires refer to “Structure-Aware Time Division Multiplex (TDM) Circuit Emulation Service over Packet Switched Network (CESoPSN)”, RFC5086, IETF, December 2007, by A. Vainshtein et al., which is incorporated herein by reference. For more information on carrying structure-agnostic TDM signals on pseudowires refer to “Structure-Agnostic Time Division Multiplexing (TDM) over Packet (SAToP)”, RFC4553, IETF, June 2006, by A. Vainshtein and Y. J. Stein, which is incorporated herein by reference.

As previously mentioned pseudowires can be statically or dynamically configured, wherein the latter can be triggered by an operator command from the management plane of a PE system, by signaling set-up or teardown of an attachment circuit, or by an auto-discovery mechanism. During the setup process, the PE systems exchange parameters relating to their respective endpoints of the pseudowire being setup. This exchange may be carried out using extensions to the tunnel signaling protocol used to establish a tunnel through the PSN for the pseudowire. In the case of TDM pseudowires over MPLS Networks, more details on these extensions, their use, and requirements can be found in IETF proposed standard “Control Protocol Extensions for Setup of TDM Pseudowires in MPLS Networks”, draft-ietf-pwe3-tdm-control-protocol-extensi-07.txt, IETF, March 2008, by A. Vainshtein and Y. J. Stein, which is incorporated herein by reference. However, since this proposed standard requires that several of such parameters exchanged by peer PE systems match in order for a pseudowire to be successfully established between the peer PE systems, a problem arises when at least one segment of the PSN tunnel used for the pseudowire is statically configured and another segment is dynamically configured.

When all segments of a PSN tunnel used for a TDM pseudowire are dynamically configured using for example MPLS LDP, interface parameters for the TDM pseudowire can be exchanged between peer PE systems using extensions described in the aforementioned proposed standard. Several of these exchanged parameters such as CEP/TDM payload bytes, CEP/TDM bit-rate, and certain TDM options must match for the pseudowire to be successfully established. In order for these parameters to be exchanged, one of the peer PE systems sends a label message containing the parameters to the other peer PE system. Each intermediate label switch router (LSR) in the path between the peer PE systems copies the parameters from an incoming forwarding equivalency class (FEC) table at an ingress service distribution point (SDP) of the LSR to an outgoing FEC at an egress SDP of the LSR, after which the LSR forwards a label message containing the parameters to the next LSR along the path, or the other peer PE system. In this manner, one peer PE system receives parameters from the other peer PE system, which enables a comparison of received and locally configured parameters to be made by that PE system, and visa versa. However, when a segment of the PSN tunnel is statically configured, there are no incoming and outgoing FEC tables associated with the SDPs of the statically configured segment, which results in a breakdown of the parameter exchange between the PE systems. This breakdown results in an inability to dynamically establish pseudowires, for example TDM pseudowires, when a segment of the PSN tunnel used by the pseudowire is statically configured.

Accordingly, a solution is needed for dynamically establishing pseudowires where at least one segment of the PSN tunnel used for the pseudowire is statically provisioned.

### SUMMARY OF THE INVENTION

Embodiments of the invention enable a pseudowire to be dynamically established over a PSN tunnel when the tunnel includes both a statically configured segment and a dynamically configured segment.

According to an aspect of the invention a method of establishing a pseudowire between two PE systems in a packet switching network is provided. The method would be performed at an intermediate system along a tunneled connection used by the pseudowire. The method includes the steps of: receiving from a first of the PE systems a message carried in the tunnel; initiating a response to the message, the response including a parameter for establishing the pseudowire; and sending the response to the first PE system.

In some embodiments of the invention the intermediate node is at a junction between a statically configured segment of the tunneled connection and a dynamically configured segment of the tunneled connection. Typically this would be the case, however it is possible for an intermediate network node to perform an embodiment of the invention when the node is not at such a junction as long as the node has determined that the junction exists or is configured so, and as long as the message is received via the dynamically configured segment and the response is sent via the dynamically configured segment.

According to another aspect of the invention a network node is provided for communicating data packets over a tunneled connection used by a pseudowire between two PE systems of a packet switching network. The network node includes: means for receiving a message for establishing the pseudowire; means for determining whether the network node is at a junction of a statically configured segment and a dynamically configured segment of the tunneled connection; and means for initiating a response to the message responsive to a determination that the network node is at the junction.

In some embodiments of the invention the means for initiating are operable to form the response by including therein a parameter for establishing the pseudowire and to send the response to a first of the PE systems over the dynamically configured segment.

Advantageously, embodiments of the invention enable a network node that supports only static, and not dynamic, tunnel and pseudowire configuration to be included in dynamically configured pseudowires. This capability can be useful in cases where functionality required for such dynamic configuration has been omitted from the network node for cost or system performance reasons. Dynamically configured pseudowires or portions thereof, have an advantage over statically configured pseudowires in being capable of reacting to network failures, for example rerouting around a failed node or link using MPLS fast reroute.

### BRIEF DESCRIPTION OF THE DRAWINGS

The invention will be further understood from the following detailed description with reference to the drawings, in which:

FIG. 1 is a diagram of a network depicting a network node that is in accordance with an embodiment of the invention establishing a pseudowire; and

FIG. 2 is a flow chart of a method of establishing a pseudowire according to another embodiment of the invention.

It will be noted that in the attached figures, like features bear similar labels.

### DETAILED DESCRIPTION

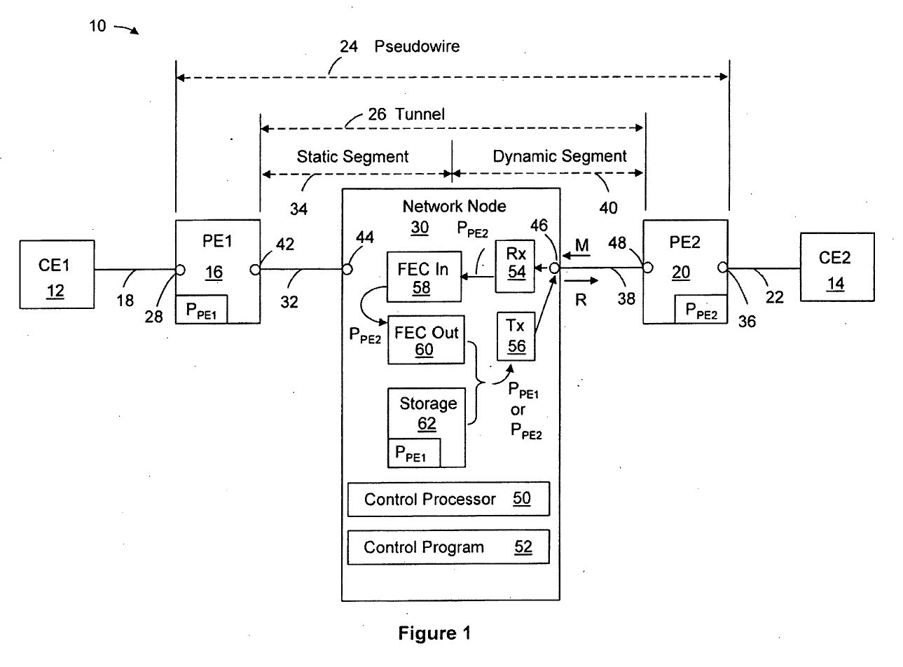

Referring to FIG. 1, a packet switching network (PSN) 10 which in this case is an MPLS network, provides Circuit Emulation Service (CES) between a first customer edge (CE) system 12 and a second CE system 14. The first CE system is connected to a first provider edge (PE) system 16 via a first attachment circuit 18, which in this case is a TDM circuit. The second CE system 14 is connected to a second PE system 20 via a second attachment circuit 22, which is also a TDM circuit. The first and second PE systems 16, 20 are label switch routers. A TDM pseudowire 24 configured between the PE systems 16, 20 provides a native telecommunications service, for example T1 leased line, over the packet switching network. As previously described with reference to the prior art, the PE systems 16, 20 provide encapsulation, decapsulation, timing and sequencing functions to communicate protocol data units (PDUs) of the native telecommunications service over the TDM pseudowire in a manner that is transparent to the CE systems 12, 14. For this purpose, a tunnel 26 is configured between the PE systems 16, 20. As mentioned previously, various types of tunnels can be used and may be configured dynamically using various tunnel signaling protocols such as L2TP, MPLS LDP, and RSVP-TE. As well, the entire tunnel 26 or segments thereof may be configured statically.

The first PE system 16 includes a first service access point (SAP) 28 associated with the CES and the first attachment circuit 18. The first PE system 16 is communicatively coupled to a network node 30 via a first path 32 through which PDUs of the CES are forwarded through a statically configured segment 34 of the tunnel 26. The network node 30 is a label switch router. Although not shown, multiple network nodes could be in the first path 32. Generally, any network nodes in the tunnel 26 between the first and second PE systems 16, 20 are referred to herein as intermediate systems of the tunnel 26. This nomenclature includes the network node 30.

The first PE system 16 has a first parameter P_{PE1} associated with the first attachment circuit 18 configured on it. The first parameter P_{PE1} specifies a value relating to the TDM circuit carried on the first attachment circuit 18. Although only one such parameter is shown there could be several of them. For example, the first parameter P_{PE1} could be any of the previously mentioned parameters such as CEP/TDM payload bytes, CEP/TDM Bit-rate, and certain TDM options specified when establishing a TDM pseudowire.

The second PE system 20 includes a second service access point (SAP) 36 associated with the CES and the second attachment circuit 22. The second PE system 20 is communicatively coupled to the network node 30 via a second path 38 through which PDUs of the CES are forwarded through a dynamically configured segment 40 of the tunnel 26. Although not shown, multiple network nodes could be in the second path 38.

The second PE system 20 has a second parameter P_{PE2} associated with the second attachment circuit 22 configured on it. The second parameter P_{PE2} specifies a value relating to the TDM circuit carried on the second attachment circuit 22. Although only one such parameter is shown there could be several of them. For example, the second parameter P_{PE2} could be any of the previously mentioned parameters such as CEP/TDM payload bytes, CEP/TDM Bit-rate, and certain TDM options specified when establishing a TDM pseudowire.

A first service distribution point (SDP) 42 associated with the statically configured segment 34 is configured in the first PE system 16. A second SDP 44 also associated with the statically configured segment 34 is configured in the network node 30. The first and second SDPs 42, 44 are assigned to static labels, and therefore they are not involved in LDP label advertisement signaling.

A third SDP 46 associated with the dynamically configured segment 40 is configured in the network node 30. A fourth SDP 48 also associated with the dynamically configured segment 40 is configured in the second PE system 20. The third and fourth SDPs 46, 48 are assigned dynamic labels, and therefore they are involved in LDP label advertisement signaling.

The network node 30 includes a control processor 50 that executes a control program 52 to perform label switch routing on PDUs among other functions. The control processor 50 and control program 52 are referred to herein in a general sense in order to simplify the description of the invention. In practice the control processor 50 would typically be part of a control card of which there could be at least two for redundancy. The control program 52 would typically contain several modules or programs being executed simultaneously on each of the redundant control cards for full redundancy. Some functions provided by the network node 30 are provided on other circuit cards such as line cards, which are not shown in the figure.

The network node 30 is at a junction between the statically configured segment 34 and the dynamically configured segment 40. This positioning in the tunnel 26 can be determined by the network node 30 by comparing the assignment of the second SDP 44, i.e. to static labels, to the assignment of the third SDP 46, i.e. to dynamic labels. Another way to enable the network node 30 to make this determination is to configure an indication of such positioning in the network node 30. The control processor 50 executing certain instructions of the control program 52 provides a means of making the determination that the network node 30 is at such a junction. This would be done by checking for the aforementioned indication or by comparing the assignment of the second and third SDPs 44, 46 as previously described.

In order to dynamically establish the pseudowire 24, the second PE system 20 sends a label message M containing the second parameter P_{PE2} to the network node 30 over the dynamic segment 40. The label message M is in accordance with LDP label advertisement signaling. The network node 30 includes a means of receiving this message M and reading the second parameter P_{PE2} contained therein. These receiving means would typically be a combination of hardware and specific software instructions provided by the control processor 50 and control program 52 and a receiver 54 which is operable to receive PDUs arriving over the second path 38. The receiver 54 would typically be implemented on a line card (not shown) of the network node 30. The network node 30 then stores the second parameter P_{PE2} in an incoming FEC table 58 associated with the third SDP 46 and the dynamically configured segment 40.

In order to finish establishing the pseudowire 24 the second PE system 20 requires a response R to the message M. The response R should contain one or more parameters relating to the pseudowire 24. The response R is in accordance with LDP label advertisement signaling. In the case of a TDM pseudowire, certain parameters in the response R should match those sent in the message M. Examples of such parameters were previously noted. Typically, when an entire tunnel over which a pseudowire is to be carried is dynamically configured, the response R would be initiated at the first PE system 16. However, in the present embodiment, since the tunnel 26 contains the static segment 34, the message M is not delivered to the first PE system 16. Therefore the response R can not be initiated from the first PE system 16.

For the purpose of responding to the message M the network node 30 includes means for initiating the response R. These means are utilized responsive to receiving the message M at the network node 30 and the network node 30 determining that it is at the junction between the static segment 34 and the dynamic segment 40. These initiating means would typically be a combination of hardware and specific software instructions provided by the control processor 50 and control program 52 and a transmitter 56 which is operable to transmit PDUs, including the response R, over the second path 38. The transmitter 56 would typically be implemented on a line card (not shown) of the network node 30.

The response R contains one or more parameters for establishing the pseudowire 24. As mentioned previously in the case of a TDM pseudowire, certain parameters sent by the second PE system 20 must match corresponding parameters received by the second PE system 20 in the response R in order for the second PE system to establish the pseudowire 24. In the embodiment presently being described, only one such parameter is described as being included in the message M and in the response R in order to simplify the description, however the reader should understand that the parameter could equally represent a set of multiple such parameters.

The network node 30 includes an outgoing FEC table 60 associated with the third SDP 46 and the dynamically configured segment 40. The outgoing FEC table 60 is capable of storing, among other things, the second parameter P_{PE2}. The control processor 50 executing specific software instructions in the control program 52 is capable of copying the second parameter P_{PE2} from the incoming FEC table 58 to the outgoing FEC table 60. This copying would be performed responsive to the network node 30 determining that it is at the junction of the static segment 34 and the dynamic segment 40, and also depending on how the network node 30 is configured. This copying functionality would be considered part of the initiating means previously mentioned.

The network node 30 also includes a storage 62 which can be used for storing, among other things, the first parameter P_{PE1}. For example, the first parameter P_{PE1} could be written into the storage 62 during, or after, configuration of the static segment 34.

The network node 30 forms the response R by including therein either the first parameter P_{PE1} read from the storage 62 or the second parameter P_{PE2} read from the incoming FEC 58, depending on how the network node 30 is configured. That is, the network node 30 is configured either to copy the second parameter P_{PE2} from the incoming FEC 58 into the outgoing FEC 60 and include the second parameter P_{PE2} in the response R, or it is configured to read the first parameter P_{PE1} from the storage 62 and include the first parameter P_{PE1} in the response R. In either case, the network node 30 initiates the response R, which includes forming and sending the response R, after it determines that it is at the junction between the static segment 34 and the dynamic segment 40. The functionality for forming and sending the response R are consider part of the aforementioned initiating means.

Upon receiving the response R, the second PE system 20 compares the parameter contained therein to the second parameter P_{PE2} stored locally. If the two parameters match, establishment of the TDM pseudowire 24 is completed and the CES is brought into service; otherwise establishment of the pseudowire 24 fails and the CES remains out of service.

This embodiment of the invention has been described with respect to TDM pseudowires. However, it should be appreciated that embodiments of the invention are not limited to TDM pseudowires. Embodiments of the invention could be employed to dynamically establish pseudowires of any type between two PE systems over a tunnel having a dynamically configured segment and a statically configured segment.

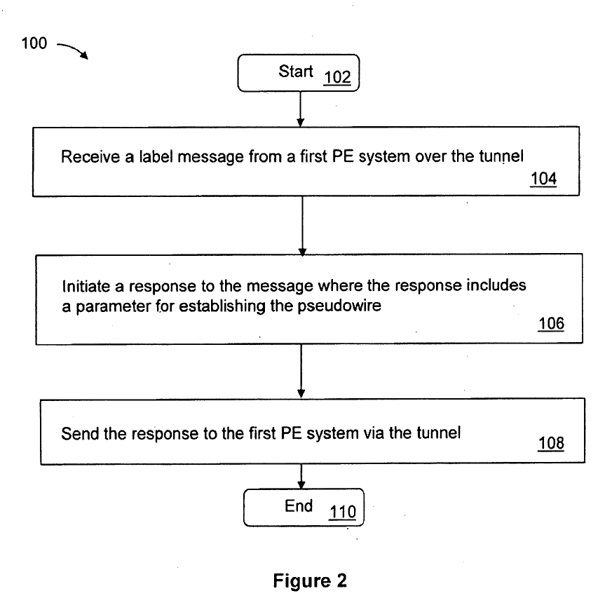

Referring to FIG. 2, a method 100 of establishing a pseudowire between two PE systems in a PSN is performed at an intermediate system along a tunnel of the pseudowire. Execution of the method is responsive to the intermediate system being at a junction between a statically configured segment of the tunnel and a dynamically configured segment. The intermediate system begins at the start 102 of the method 100 and proceeds to a step 104 of receiving a message from a first of the PE systems via the tunnel. The intermediate system receives the message over the dynamically configured segment. Next, the intermediate system proceeds to a step 106 of initiating a response to the message, where the response includes a parameter for establishing the pseudowire. The intermediate node then proceeds to a step 108 of sending the response to the first PE system via the dynamically configured segment of the tunnel. Whereupon receiving the response the first PE segment compares the parameter to one stored locally and, consequent to the parameters matching each other, completes establishment of the pseudowire.

Numerous modifications, variations and adaptations may be made to the embodiment of the invention described above without departing from the scope of the invention, which is defined in the claims.

What is claimed is:

1. A method of establishing a pseudowire between two provider edge systems in a packet switching network, the method comprising the steps of:
at an intermediate system along a tunnel of the pseudowire:
receiving a message from a first of the provider edge systems, the message carried in the tunnel;
initiating a response to the message, the response including a parameter for establishing the pseudowire; and
sending the response to the first provider edge system.

2. The method of claim 1 wherein the intermediate node is at a junction between a statically configured segment of the tunnel and a dynamically configured segment of the tunnel, and wherein:
the step of receiving comprises receiving the message from the dynamically configured segment; and
the step of sending comprises sending the response over the dynamically configured segment.

3. The method of claim 2 wherein the message includes the parameter and wherein:
the step of receiving further comprises reading the parameter from the message; and
the step of initiating comprises forming the response using the parameter.

4. The method of claim 3 wherein:
the step of receiving further comprises storing the parameter in an incoming table associated with the dynamically configured segment; and
the step of initiating comprises copying the parameter from the incoming table to an outgoing table associated with the dynamically configured segment.

5. The method of claim 4, wherein the incoming and outgoing tables are forwarding equivalency class tables.

6. The method of claim 5, wherein the message is received and the response is sent over the dynamically configured segment of the tunnel using a multiprotocol label switching label distribution protocol.

7. The method of claim 1 wherein the intermediate system is a label switch router.

8. The method of claim 2 wherein the parameter has been configured at a second of the two provider edge systems and is associated with the statically configured segment of the tunnel.

9. The method of claim 8, wherein the parameter is locally stored at the intermediate system and the wherein the step of initiating comprises:
reading the parameter from a local storage at the intermediate system; and
forming the response using the parameter.

10. The method of claim 9, wherein the message is received and the response is sent over the dynamically configured segment of the tunnel using a multiprotocol label switching label distribution protocol.

11. A network node for communicating data packets over a tunneled connection used by a pseudowire between two provider edge (PE) systems of a packet switching network, the network node comprising:
means for receiving a message for establishing the pseudowire;
means for determining whether the network node is at a junction of a statically configured segment and a dynamically configured segment of the tunneled connection; and
means for initiating a response to the message responsive to a determination that the network node is at the junction.

12. The network node of claim 11, wherein the means for initiating are operable to form the response by including therein a parameter for establishing the pseudowire and to send the response to a first of the PE systems over the dynamically configured segment.

13. The network node of claim 12, wherein the means for receiving are operable to read the parameter from the message.

14. The network node of claim 13, wherein the network node further comprises:
an incoming table associated with the dynamically configured segment; and
an outgoing table associated with the dynamically configured segment, and
wherein the means for receiving are further operable to store the parameter in the incoming table and the means for initiating are further operable in forming the response to copy the parameter from the incoming table to the outgoing table.

15. The network node of claim 14, wherein the incoming and outgoing tables are forwarding equivalency class tables.

16. The method of claim 15, wherein the means for receiving and the means for initiating are further operable to respectively receive the message and send the response over the dynamically configured segment using a multiprotocol label switching label distribution protocol.

17. The method of claim 12, wherein the parameter has been configured at a second of the two PE systems and is associated with the statically configured segment of the tunnel, and the network node further comprises:
storage means for storing the parameter, and
wherein the means for initiating are further operable to read the parameter from the storage means.

18. The method of claim 17, wherein the means for receiving and the means for initiating are further operable to respectively receive the message and send the response over the dynamically configured segment using a multiprotocol label switching label distribution protocol.

19. The network node of claim 18, wherein the means for determining comprises means for comparing a first service distribution point (SDP) associated with the statically configured segment and provisioned on the network node with a second SDP associated with the dynamically configured segment and provisioned on the network node.

20. The network node of claim 19, wherein the network node is a label switch router and the first SDP is assigned to static labels and the second SDP is assigned to label distribution protocol (LDP) label advertisement signaling.
